(19) United States
(12) Patent Application Publication
(10) Pub. No.: US 2026/0287070 A1
(43) Pub. Date: Sep. 24, 2026

(54) BALL VALVE ASSEMBLY HAVING ADJUSTABLE HANDLE POSITIONS

(71) Applicant: Caleffi S.P.A., Fontaneto D'Agogna (IT)

(72) Inventor: MARCO CALEFFI, BORGORMANERO (IT)

(73) Assignee: CALEFFI S.P.A., FONTANETO D'AGOGNA (IT)

(21) Appl. No.: 19/084,179

(22) Filed: Mar. 19, 2025

(51) Int. Cl. F16K 5/06; G01N 1/20

(52) U.S. Cl. CPC F16K 5/0605; F16K 5/0626; F16K 5/0647; G01N 1/2035; G01N 2001/205

(57) ABSTRACT

A valve assembly with multi-directional positioning. The valve assembly has a positioning mechanism that allows for the valve assembly be closely installed near a wall or flat or surface or closely installed to an opposite wall of flat surface during the installation process, while maintaining the proper flow direction through the valve assembly in either orientation. The valve assembly includes a test port maintained at a constant pressure, regardless of whether the ball valve assembly is in an open or closed position.

### BACKGROUND OF THE INVENTION

The present invention is related to valve assemblies, and, more particularly, to valve assemblies for controlling pressure and fluid flow through the valve.

Valve assemblies are commonly used to regulate the flow of fluids through pipes and conduits. One common type of valve is a ball valve, which has a pivoting ball located within a conduit or housing. The ball has an opening in it, which can be pivoted by using a handle from one position to another, open or close, to either allow fluid to flow through the opening in the ball or to prevent fluid flow.

While commonly used, there are shortcomings for ball valves. For space and efficiency, piping and conduits are generally positioned close to a wall or other surface, which limits the range of the ball valve when attached or used. Since a ball valve assembly turns from an initial open position to a second closed position that is 90° from the first position, an assembly that may be adequate for use on piping near a first wall may not be useful on an opposing wall, as the opposing wall may impede pivoting of the handle.

Another issue with current valve assembly is the ability to properly monitor the conditions of valve assembly, including when the valve moves from an open to closed position, independently of the valve itself.

The present invention contemplates these and other issues with current valves,

### Summary of the Invention

The present invention is directed towards a ball valve assembly. The ball valve assembly may comprise one or more integrated ball valves.

The ball valve assembly includes at least one ball valve that can be moved from an open to a closed position with the use of a handle. The assembly includes backflow preventer. The ball valve assembly is designed so that it can be mounted close to a wall, with the backflow preventer close to the wall, as well. Irrespective of the location of the wall, i.e. which wall of a room or building the assembly is mounted near, the handles are easily accessible to open and close the ball valve.

The ball valve assembly of the present invention includes at least one test port. The test port is maintained at a constant pressure, regardless of whether the ball valve assembly is in an open or closed position.

The ball valve assembly of the present invention generally comprises a housing for a ball valve that is in communication with a test port. The ball valve comprises a ball movable between an open and closed position. A handle or handles will be used to move the ball valve from an open to a closed position. The ball includes a port, which allows pressure to the test port in both the open and closed positions of the ball valve.

The ball valve assembly is designed for the handle positions to be changed if needed. The ball valve assembly includes a positioning guide that allows an installer to change the handle positioning 180° prior to installation.

The present invention also comprises methods for adjusting the rotation of the handle, while allowing fluid flow through the valve assembly to be maintained in the same direction if the position of the valve assembly needs to be spatially moved with respect to the installation area. This can be done prior to installation.

These and other features of the present invention will be described in detail below.

### BRIEF DESCRIPTION OF THE DRAWINGS

FIG. 1 is a perspective view of a ball valve assembly of the present invention, with the ball valve assembly being in the open position.

FIG. 2 is a perspective view of a ball valve assembly of the present invention, with the ball valve assembly being in the closed position.

FIG. 3 is a front perspective view of the ball valve assembly as demonstrated in FIG. 1.

FIG. 4 is a cross-sectional view of the valve assembly shown in FIG. 3 taken along the line 4 -4 of FIG. 3.

FIG. 5 is a front perspective view of the ball valve assembly as demonstrated in FIG. 2

FIG. 6 is a cross-sectional view of the valve assembly shown in FIG. 3 taken along the line 6 -6 of FIG. 5.

FIG. 7 is an exploded view of the valve assembly shown in FIG. 1.

FIGS. 8-11 are perspective views of the housing of the valve assembly detailing an attachment area for a handle used in the present invention,

FIG. 12 is a perspective view of another embodiment of the valve assembly according to the present invention in an open position.

FIG. 13 is a perspective the valve assembly shown in FIG. 12 in a closed position.

FIG. 14 is a side view of the valve assembly of FIG. 13.

FIG. 15 is a side view of the valve assembly of FIG. 12.

FIGS. 16 and 17 provide perspective views of a ball used in a ball valve of the present invention.

FIG. 18 is a perspective view of the ball valve assembly of the present invention positioned in an open position against a wall.

FIG. 19 is a perspective view of the ball valve assembly of FIG. 18 in the closed position.

FIG. 20 is a perspective view of the ball valve assembly of FIG. 18 positioned against a wall that is oppositely located to the wall in FIGS. 18 and 19.

FIGS. 21-24 are partial view of a ball valve assembly of the present invention, demonstrating various steps to change the direction of the handle, e.g. left to right, while maintaining the fluid flow direction through the valve assembly, if the valve assembly is moved to a different spatial location in the installation area.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

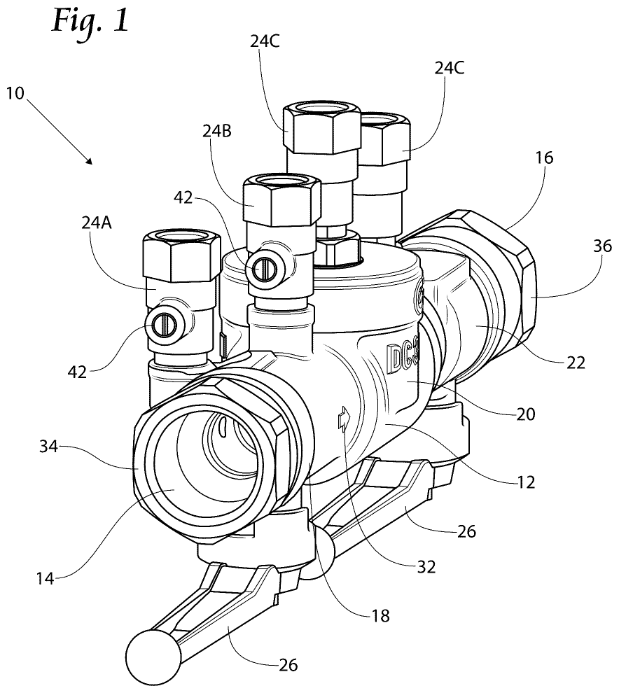

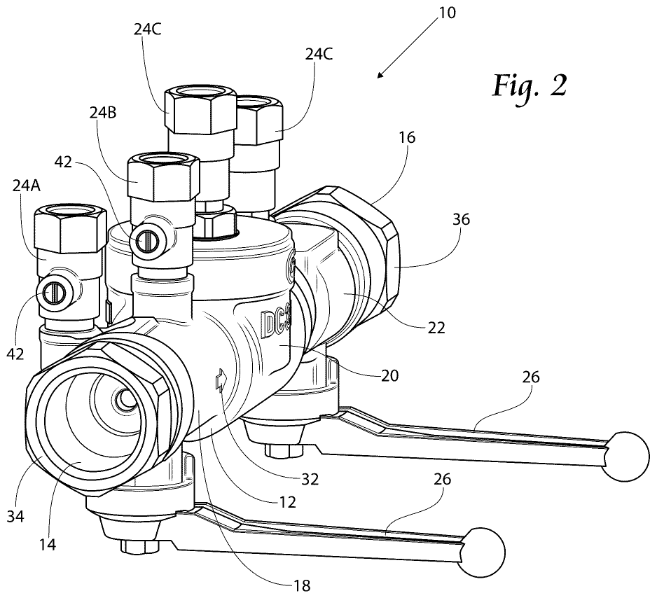

FIGS. 1 and 2 depict a valve assembly 10 according to the present invention. The valve assembly generally comprises a housing 12 having a first end 14 and a second end 16. The housing 12 generally comprises a front section 18, a central section 20, and a back section 22. A plurality of test ports 24 (indicated at 24a, 24b, and 24c) are located on the housing 12.

Still referring to FIGS. 1 and 2, a respective handle 26 is pivotally attached to the housing 12 at the front section 18 and the back section 22. The handles 26 are positioned in an open configuration to allow flow of fluid through the assembly 10, including the port 24a, while in FIG. 2 the handles 26 are in a closed position, The handles 26 move independently so that one may be in a closed position while the other is in an open position.

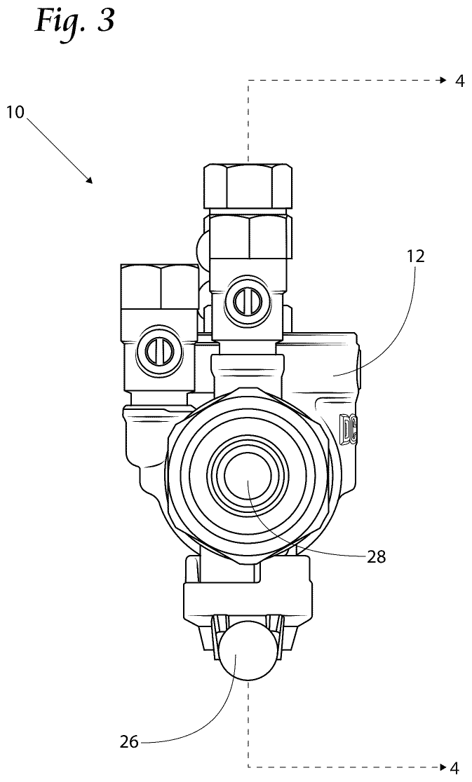

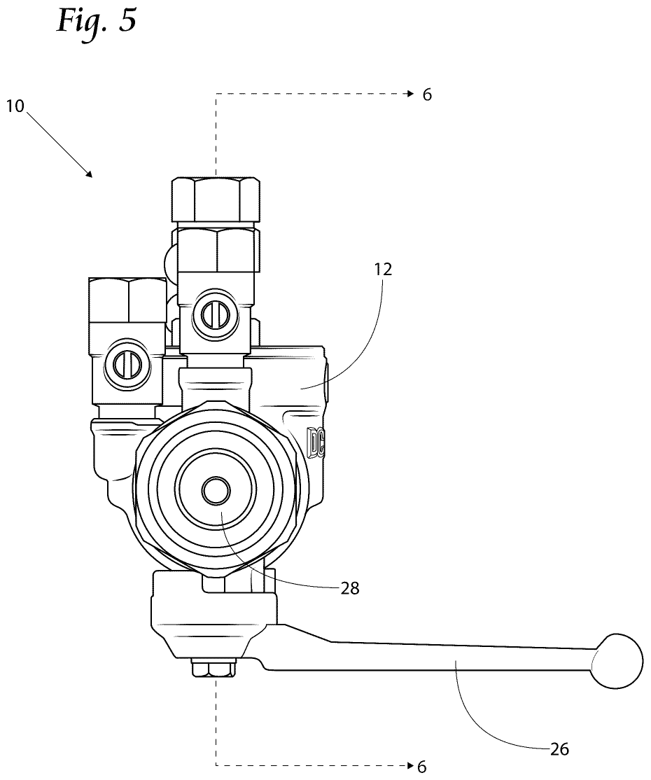

Referring now to FIGS. 3 and 5, the valve assembly 10 is shown from a front view, also in an open position (FIG. 3) and a closed position (FIG. 5). The handle 26 is connected to a ball 28 which either allows fluid flow in the open position (FIG. 3) or prevents fluid flow in the closed position (FIG. 5).

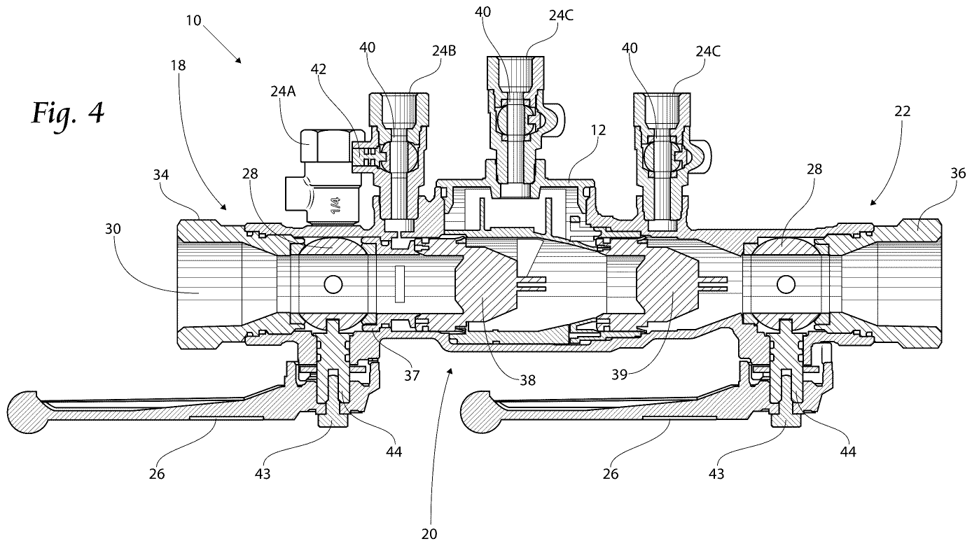

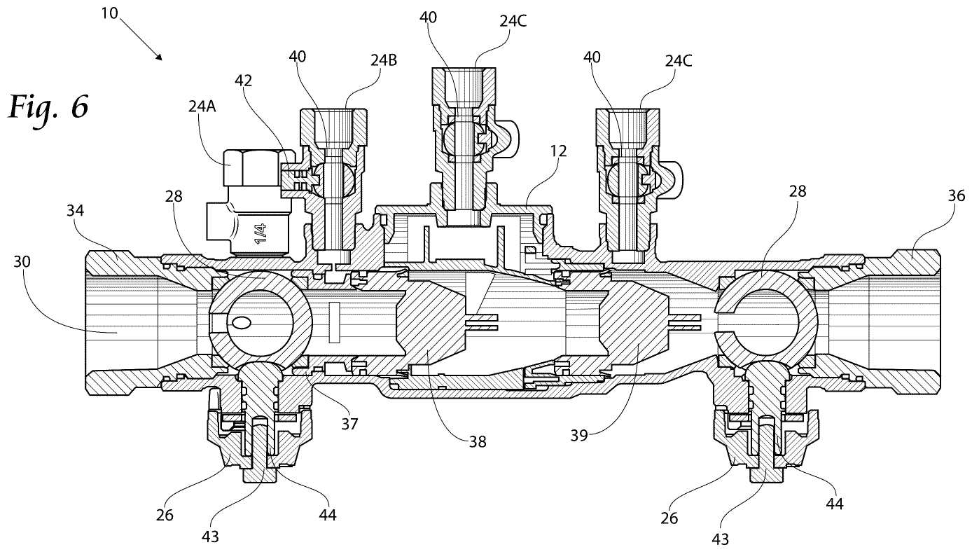

FIGS. 4 and 6 provide cross-sectional views of the valve assembly 10 in the open position (FIG. 4) and the closed position (FIG. 6). The valve assembly provides a conduit 30 for fluid flow through the housing 12 of the valve assembly 10. The conduit 30 passes through the front section 18, the central section 20 and then the back section 22. Fluid will flow through the conduit. As shown in FIG. 1, a flow indicator 32, e. g. an arrow, is used on the valve assembly 10 to assist with installation and maintenance of the valve assembly 10 when installed and to indicate the proper direction of the fluid flow (see FIG. 1).

Still referring to FIGS. 4 and 6, each of the balls 28 is shown positioned within the front section 18 and the back section 22, with end caps 34 and 36 holding the balls 28 in place. The end caps 34 and 36 are preferably threaded onto the housing 12 to retain and position the balls 28 within the conduit 30. The ball 28 located in the front section 18 also is seated within a ball housing 37, with a first check valve 38 positioned between the front section 18 and the center section 20. Each of the balls 28 may be designed to allow fluid flow to a respective port 24, or the balls 28 may be designed so that only one ball 28 provides continuous pressure to a respective port 24, as needed or desired. A second check valve 39 is positioned between the center section 20 and the back section 22, positioned in the same direction as the first check valve.

Still referring to FIGS. 4 and 6, the test ports 24 are shown to include a respective fluid pathway 40 is located within each of the test ports 24. The test ports 24 are generally ball valves and operate as such that can be moved between an open and closed position. The test ports are secured to the housing 12. The fluid pathways 40 intersect the conduit 30 and allow for monitoring of the pressure within the valve assembly 10. An adjustment device 42 is also located on the test port 24 and intersects the fluid pathway 40. The adjustment device 42 can be rotated to move the test port between an open and closed position. Because the test port 24a is positioned separately and independently from the ball 28, the pressure in the test port 24a will always be upstream of the ball 28, while maintaining fluid flow in the proper direction, This allows for testing of the valve assembly, regardless of the orientation (open or closed) of the ball valve 28.

FIGS. 4 and 6 also show the handles 26 engaging the stems associated with the respective balls 28. A stem 44 is inserted into each of the balls 28 and extends down into the handle 26. A securing means 43, e.g. a screw or bolt, retains the handle in connection with the stem 44. Preferably, the stem 44 is cylindrical and is inserted into the housing 12 to retain it in place, The stem 44 can be positioned with the use of the O-rings Or similar seals that allow the stems 44 to rotate the balls 28 when engaged.

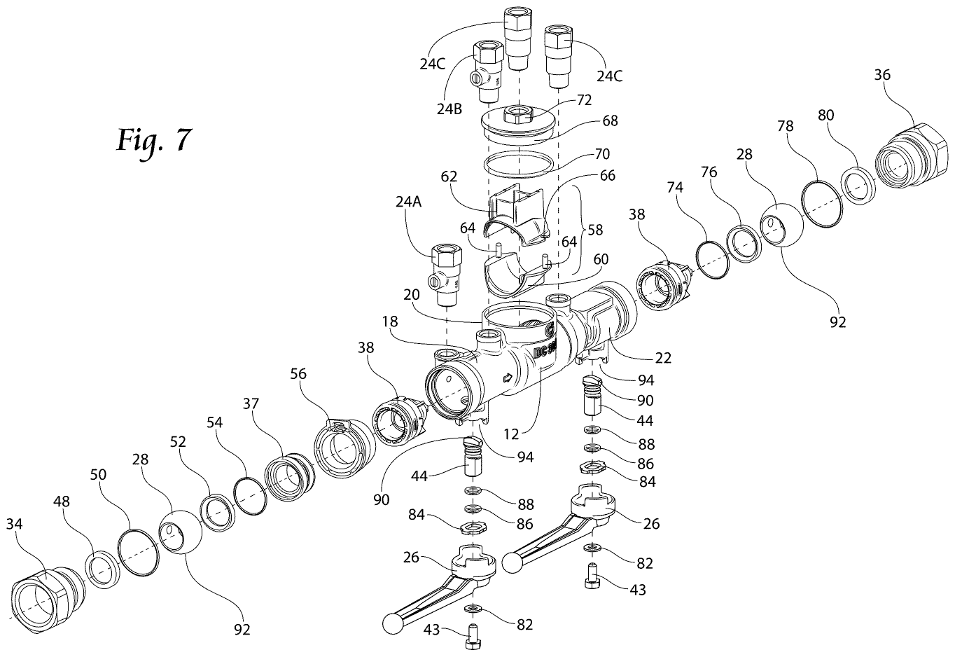

FIG. 7 provides an exploded view of the valve assembly 10. The end cap 34 attached to the front section 18 is in contact with the ball 28. A washer 48 and an O-ring 50 are positioned between the end cap 34 and the ball. A second washer 52 and a second O-ring 54 are positioned between the ball 28 and the ball housing 37. The ball housing 37 retains a retention ring 56 that helps to secure the ball in place. These elements are compressed and secure with one another so that they can be nested within the front section 18, along with the check valve 38. The arrangement provides a fluid tight arrangement.

FIG. 7 also shows an exploded view of the center section 20 of the housing 12. An internal housing 58 comprised of a bottom section 60 and a top section 62 rests within the center section 20. The bottom section 60 and the top section 62 are fit together with one another, with a pair of post 64 engaging a pair of indents 66. The internal housing 58 will be retained within the center section with a cap 68 that matingly fits with the center section 20. An O-ring 70 is situated between the internal housing 58 and the cap 68 to provide a fluid secure arrangement, One of the test ports 24 can be secured to the cap 68 by inserting the port 24 into an opening 72.

FIG. 7 also shows the back section 22 and the various components housed within the back section. The check valve 38 is shown next to an O-ring 74 and a washer 76, which are positioned between the check valve 38 and the ball 28. Another O-ring 78 and another washer 80 are positioned between the ball 28 and the end cap 36. The elements are secured within the back section 22 in fluid-tight arrangement.

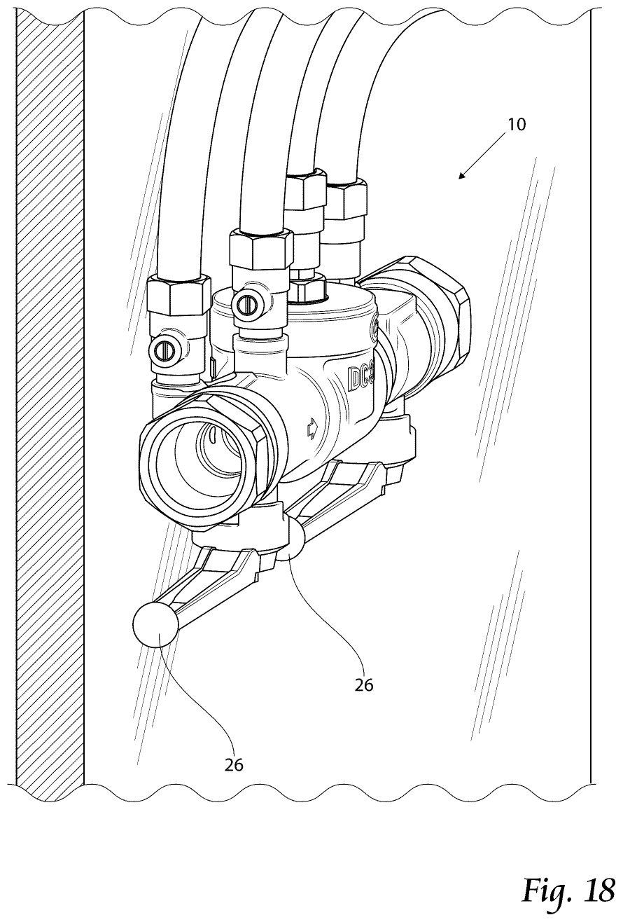

The handles 26 are shown in FIG. 7. As previously stated, the securing means 43 is inserted into the stem 44 to secure the handles 26 to the housing 12. A washer 82 is situated between the securing means 43 and the handle. A position guide 84 is nestled within the handle 26, in between the stem 44 and the handle. A pair of washers 86 and 88 may also sit upon the position guide 84. The elements are then secured within the housing as previously noted, with a ridge 90 engaging the slot 33 (see FIGS. 16 and 17) in the ball 28 so that the ball 28 may be rotated.

When assembling the valve assembly 10, the stem 44 is assembled in the closed position, which allows the ball 28 to be slid into place. The design of the ball 28 will be described further with respect to FIGS. 16 and 17. The stem 44 is preferable assembled in position prior to the ball being inserted into the valve assembly 10.

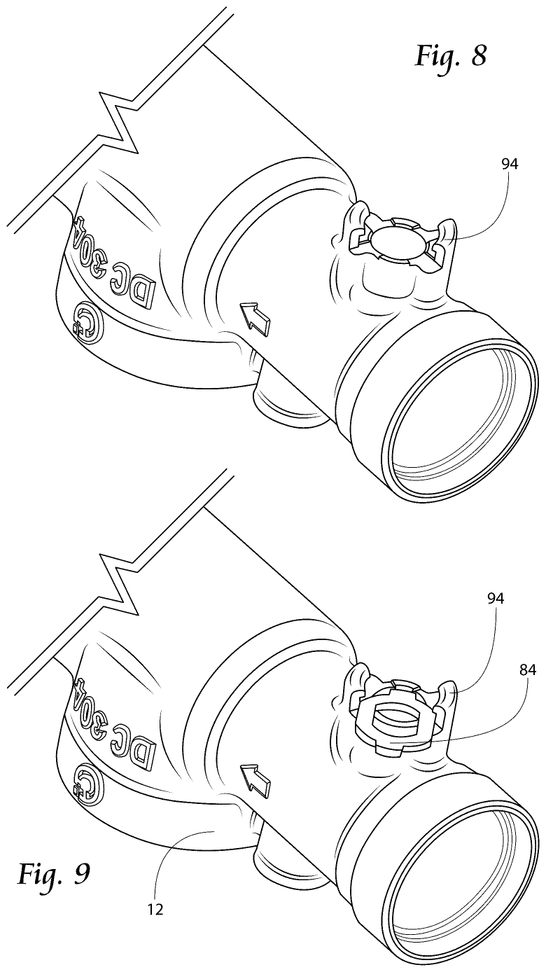

FIGS. 8-11 are perspective views of the housing 12, particularly focusing on the underside of the housing 12. The Figures describe how the stem 44 interacts with the housing 12, the ball, and the handle 26. Particularly, the positioning guide 84 is also seated within a mating section 94 located on the housing 12. The positioning guide 84 is preferably slid into the mating section 94, similar to a drawer being slid into a dresser. The positioning guides 84 is then preferably positioned in place in a manner that will allow it to rotate after being inserted. The stem 44 will then be inserted, assembled, and attached to the handle 26 through the slot 33 as previously described. The stem 44 will be positioned through the slot 33 in the housing 12 before the ball 28 can be put into position, The handle 26 can then be attached.

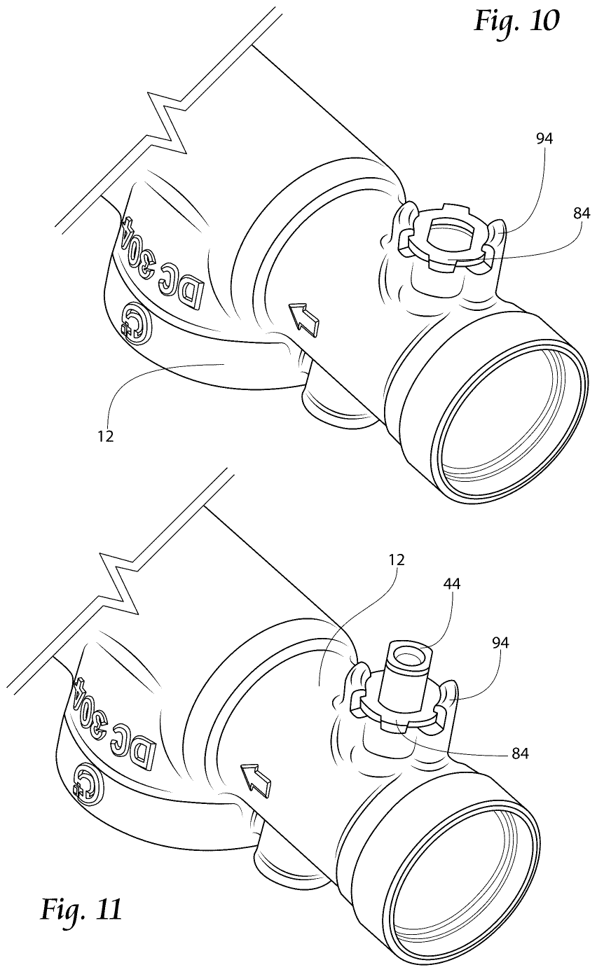

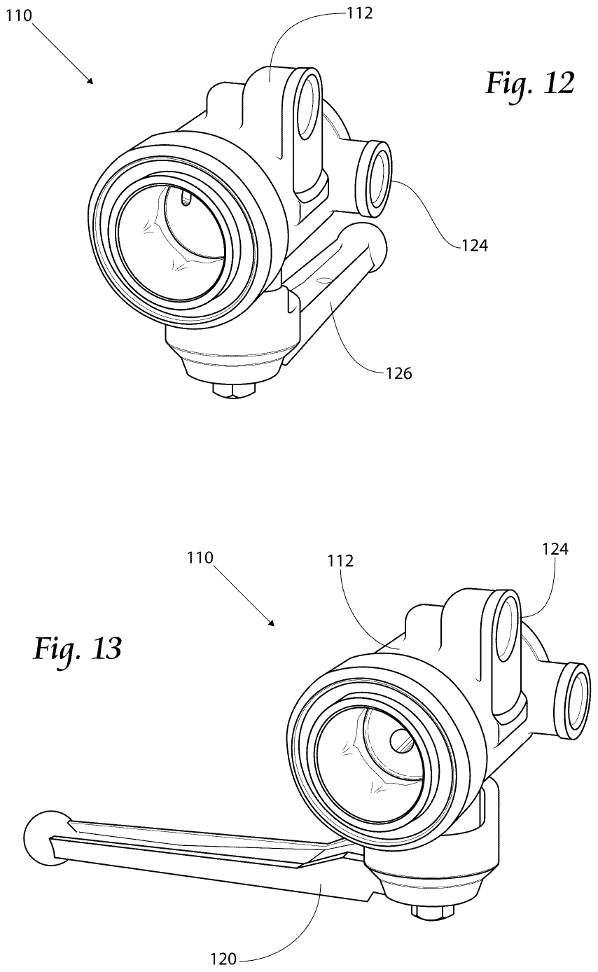

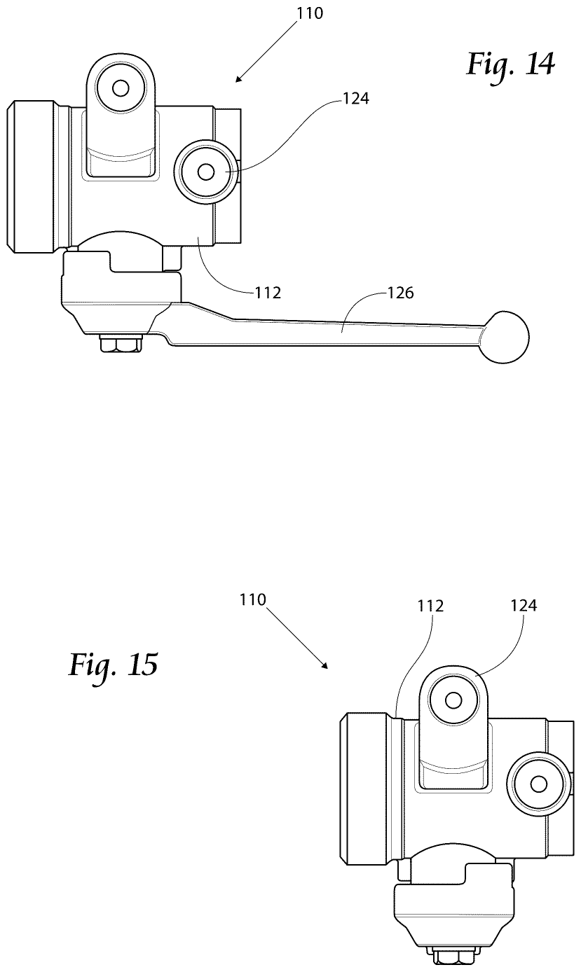

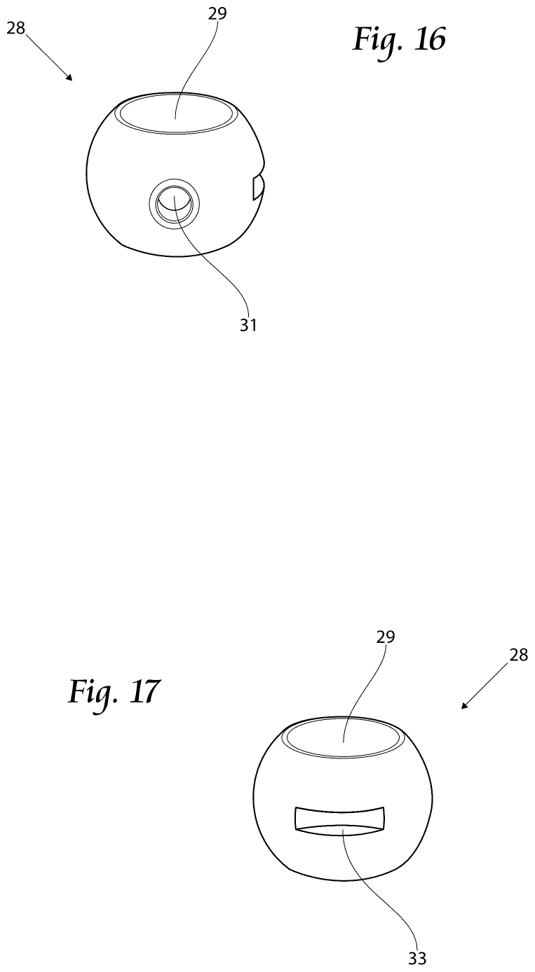

FIGS. 12-15 provide an alternate valve assembly 110 that embodies features of the present invention. The valve assembly 110 has a housing 112, which is designed for housing a singular ball 28 (FIGS. 8 and 9), The housing also supports a test port 124, as with the previous design. The valve assembly 110 is attached to handle 126 in the similar fashion as previously described. The alternate valve assembly shows that the features Of the present invention can be incorporated into single valve assembly and such arrangements would fall within the scope of the present invention.

FIGS. 16 and 17 provide perspective view of the ball 28 used in a ball valve of the present invention. As mentioned above, one of the key features of the present invention is that the arrangement of the valve assembly allows pressure to a test port, regardless if the ball valve is in an open position (e.g. FIGS. 1 and 4) or in a closed position (e.g. FIGS. 2 and 6). The ball 28 has a general central opening 29 that will align with the conduit 30 (FIGS. 4 and 6) when the ball valve is in an open position. The ball has a port opening 31 that will be in communication with a test port 24 when a ball valve is in an open position, thereby allowing pressure to the test port. When the ball valve is in a closed position, the conduit will be in communication with a test port, also allowing pressure to the test port.

FIG. 17 provides a bottom perspective view of the ball 28 showing a slot 33 that will allow the stem 44 to be inserted into the ball 28, as previously noted, e.g. FIGS. 4 and 6). The arrangement allows for the ball 28 to be easily turned from an open to closed position.

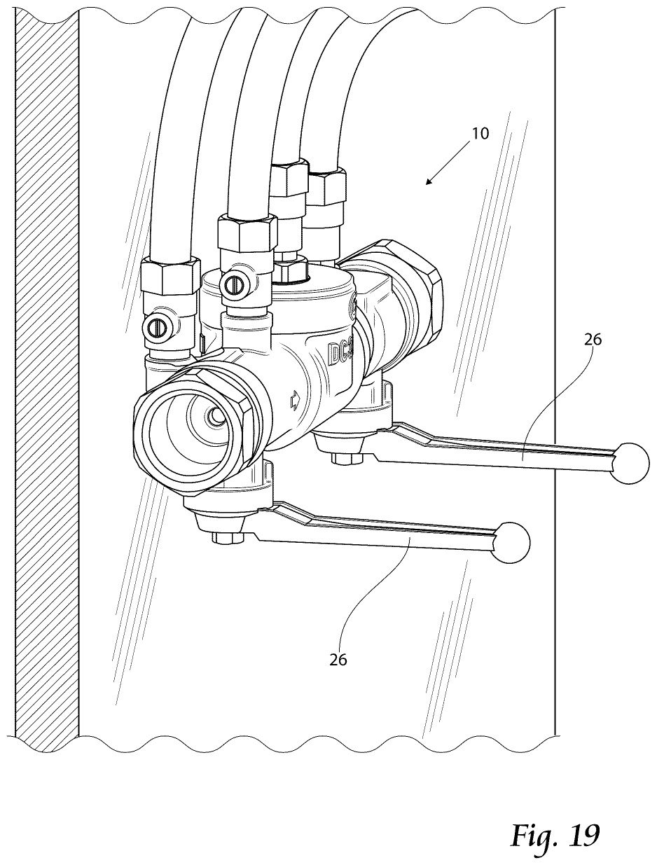

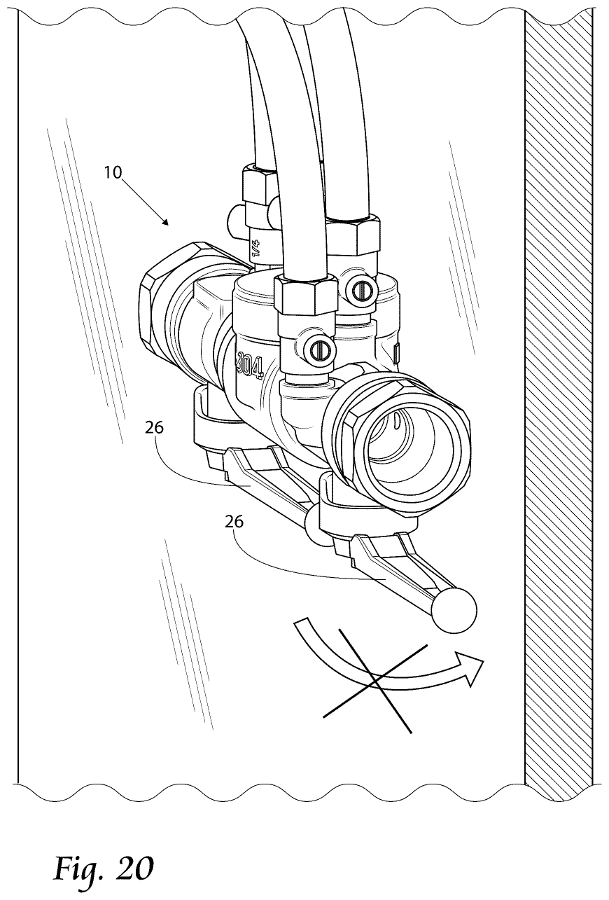

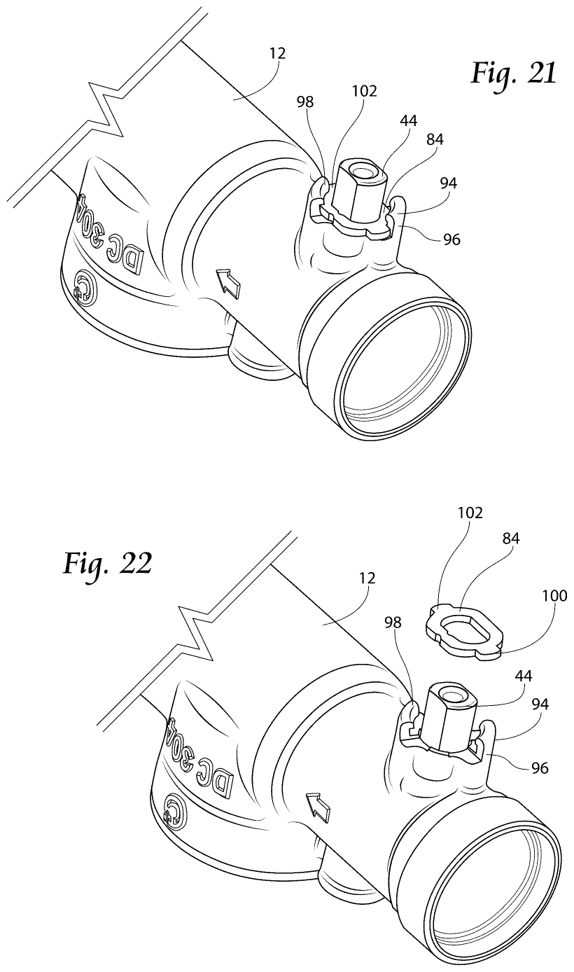

As has been noted above, the present invention is unique in that it allows for an installer to adjust the handle direction while maintaining the fluid flow direction through the ball valve assembly prior to installation, regardless of spatial positioning in the installation area, e.g. installation near different walls. Purchased valve assemblies will have the same construction and the same features, e.g. will move the same direction from open to close. Typically, the valve assemblies are designed so that they may be installed near a wall, as in FIG. 18, or they may be designed to be installed next to the opposing or opposite wall of a room or building (FIG. 20), However, a valve assembly is typically not configured to operate properly in close proximity to both walls. The valve assembly 10 can move from a closed position (FIG. 18) to an open position (FIG. 19) as needed by moving the handles 26. The same valve arrangement situated near the opposing wall as shown in FIG. 20, will not move to a closed position, as the wall will impede the movement of the handle 26. The present invention addresses this issue.

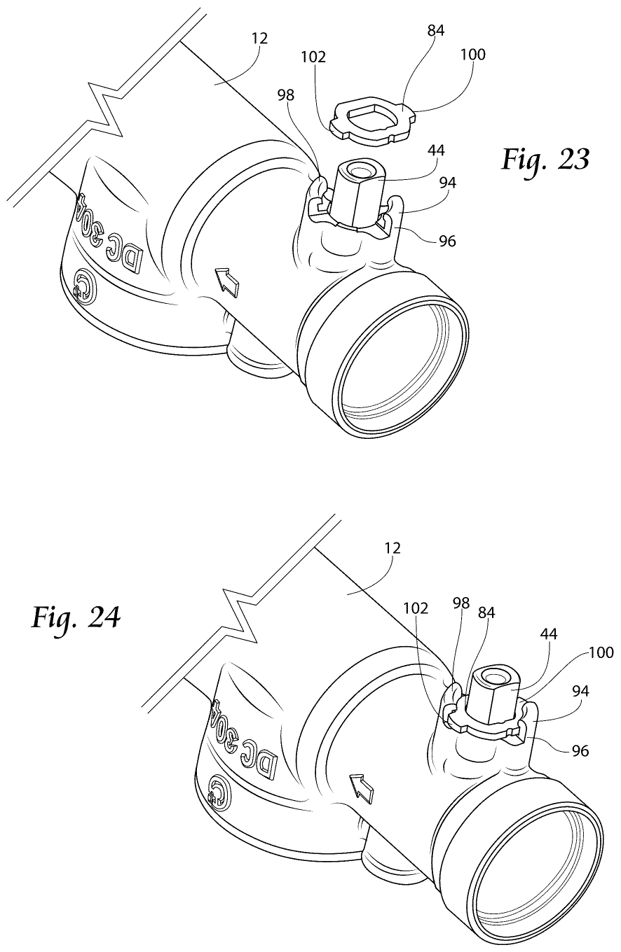

FIGS. 21-24 show perspective views of the housing 12, with various steps in adjusting the handle of of the valve assembly to be adjusted 180° as discussed above. As an example, the arrangement in FIG. 21 could correspond to the positioning as shown in FIG. 18. The position guide 84 is situated with the mating section 94. The position guide 84 and the mating section 94 are situated and nestled around the stem 44. The mating section 94 further comprises a first abutment section 96 and a second abutment section 98, which are preferably oppositely disposed of one another. The position guide 84 also has a first tab 100 and a second tab 102 that also are preferably oppositely disposed of one another. The tabs 100, 102 are designed to be positioned against the abutment sections 96, 98 when either the open or closed position.

As mentioned previously, the installer may realize that the orientation of the handles 26 on the valve assembly 10 may not allow for the valve assembly 10 to be installed near a wall or surface, e.g. the orientation of FIG. 18 is not ideal for FIG. 20. In such an instance, as demonstrated in FIG. 21, the installer will remove the handles and adjust it 180°. As shown in FIG. 22. The position guide 84 is positioned within the mating section 94 as shown in FIG. 22, and does not need to be removed for the installer to properly adjust the handle.

The installer will properly situate position guide 84 as shown in FIG. 23, with the position guide 84 being arranged so that the tabs 100, 102 abut the opposite sides of the abutment sections 94 shown in FIG. 21. The resultant arrangement is shown in FIG. 24. The valve assembly 10 can then be reassembled and installed for proper use near an opposing wall or surface, e.g. FIG. 20. However, as noted above, the design of the present invention allows for proper adjustment by moving the handle and not the position guide.

The design of the present invention also has further advantages over prior art valves. With the arrangement of the positioning guide 84 and the abutment sections 96 and 98 as shown in FIGS. 21-24, the positioning guide 84 alignment is maintained even without the handle being attached. Thus, if the handle were to inadvertently be removed or become loose, the abutment sections and the tabs would assist the installer in properly repositioning the handle and not have to search for the proper alignment.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

We claim:

1. A valve assembly comprising:
a housing having a conduit for fluid flow;
a valve located within the housing;
a test port connected to the housing and in fluid communication with said conduit, said test port communicating upstream of said valve;
a handle connected to the valve, said handle capable of moving the valve between an open position and a closed position;
wherein the test port receives pressure in both the open and closed position.

2. The valve assembly according to claim 1, wherein the valve is a ball valve assembly.

3. The valve assembly according to claim 2, wherein the ball valve further comprises a ball having a central opening for fluid flow and a direct pressure port opening located on the ball.

4. The valve assembly according to claim 3 wherein said test port opening is in fluid communication with said test port when said valve assembly is in an open position or closed position.

5. The valve assembly according to claim 4, wherein said test port further comprises a ball valve.

6. A valve assembly for providing fluid flow, the valve assembly capable of being positioned near a vertical surface, the assembly comprising:
a housing having a conduit for fluid flow;
a valve located within said housing;
a stem in communication with said valve;
a handle connected to said stem for moving said valve from an open to a closed position;
a mating section located on said housing;
a positioning guide removably secured to said mating section, said positioning guide holding said stem rotationally in place, thereby allowing said valve assembly to be assembled near said vertical surface, maintaining fluid flow direction through said valve assembly.

7. The valve assembly according to claim 6, wherein said valve further comprises a ball valve including a ball, said ball having a slot for receiving said stem.

8. The Valve assembly according to claim 7, wherein said valve assembly further comprises a test port in fluid communication with said housing.

9. The valve assembly according to claim 8, wherein said test port is capable of receiving pressure in an open or closed position.

10. A method of installing a valve assembly near a flat surface:
providing ball valve assembly having a removable and adjustable handle and a positioning guide, said handle capable of moving from an open position parallel to said flat surface to a close position perpendicular to said flat surface;
determining whether the orientation of the handle allows for the closed position turns inwardly towards the wall or outwardly from the wall;
if the determined position turns inwardly towards the wall, adjust the orientation so that it turns outwardly from the wall; and
installing the ball valve assembly,
wherein said positioning guide prevents incorrect orientation of the ball valve assembly prior to the handle being attached to the ball valve assembly.

11. The method of claim 10, wherein the ball valve assembly further comprises:
a housing;
a valve located within said housing;
a stem intersecting said valve and extending outwardly of said housing;
a handle connected to said stem;
a mating section located on said housing; and
a positioning guide removably secured to said mating section, said positioning guide holding said stem in place; and
adjusting the orientation of said handle 180°, thereby allowing said ball valve assembly to be assembled near said vertical surface while maintaining same fluid flow through said ball valve assembly.
